(19) United States
(12) Patent Application Publication
(10) Pub. No.: US 2012/0008513 A1
(43) Pub. Date: Jan. 12, 2012

(54) METHOD AND APPARATUS FOR DETECTING TARGET FLOW IN WIRELESS COMMUNICATION SYSTEM

(75) Inventors: Seung Min BAEK, Yongin-si (KR); Sang Ig RHO, Suwon-si (KR); Ho Cheol LEE, Suwon-si (KR); Jong Hun KIM, Seongnam-si (KR); Jae Jin KIM, Yongin-si (KR)

(73) Assignee: SAMSUNG ELECTRONICS CO. LTD., Suwon-si (KR)

(21) Appl. No.: 13/178,820

(22) Filed: Jul. 8, 2011

(30) Foreign Application Priority Data
Jul. 9, 2010 (KR) 10-2010-0066100

(51) Int. Cl. H04W 24/00; H04L 12/26

(52) U.S. Cl. 370/252

(57) ABSTRACT

An apparatus and method for detecting a target flow in a wireless communication system are provided. The target flow detection method includes receiving a packet, determining a behavior state of the packet, comparing the behavior state with a plurality of stored behavior signatures, retrieving, when the behavior state matches one of the stored behavior signatures, a target flow corresponding to the behavior signature, and instructing a packet processor to process the target flow.

### PRIORITY

This application claims the benefit under 35 U.S.C. §119(a) of a Korean patent application filed on Jul. 9, 2010 in the Korean Intellectual Property Office and assigned Serial No. 10-2010-0066100, the entire disclosure of which is hereby incorporated by reference.

### BACKGROUND OF THE INVENTION

1. Field of the Invention

The present invention relates to a communication apparatus and method in a wireless communication system. More particularly, the present invention relates to an apparatus and method for detecting a target flow in a wireless communication system.

2. Description of the Related Art

The 3^{rd} Generation asynchronous mobile communication system is a Universal Mobile Telecommunication Service (UMTS) system based on Code Division Multiple Access (CDMA) and evolved Global System for Mobile Communications (GSM) and General Packet Radio Services (GPRS). The standardization organization 3rd Generation Partnership Project (3GPP) has proposed Evolved Packet System (EPS) as the next generation wireless communication system for UMTS. The next generation wireless communication system aims to provide high speed high quality packet transmission services.

In a wireless communication system, a packet inspection device performs Deep Packet Inspection (DPI) in order to allocate resources such as frequency bandwidth to a plurality of terminals. The packet inspection device identifies the resource usage per communication terminal and authenticates the validity in real time. The packet inspection device can also determine the resource allocation per communication terminal and determine the resource amount to be allocated. In this manner, the resource allocation can be managed efficiently in the wireless communication. The packet inspection device performs the DPI to determine the content of the packet. The packet inspection can perform the DPI using a port matching algorithm or a string pattern matching algorithm.

However, the conventional packet inspection device has difficulty performing the DPI on an encrypted packet in the wireless communication. This is because it is difficult to determine the content of the encrypted packet. There is therefore a need of a method for performing DPI, without checking the content of the packet in a wireless communication system.

### SUMMARY OF THE INVENTION

Aspects of the present invention are to address at least the above-mentioned problems and/or disadvantages and to provide at least the advantages described below. Accordingly, an aspect of the present invention is to provide a target flow detection apparatus and method that is capable of performing the deep packet inspection without checking the content of the packet in a wireless communication system.

In accordance with an aspect of the present invention, a target flow detection method of a wireless communication system is provided. The method includes receiving a packet, determining a behavior state of the packet, comparing the behavior state with a plurality of stored behavior signatures, retrieving, when the behavior state matches one of the stored behavior signatures, a target flow corresponding to the behavior signature, and instructing a packet processor to process the target flow.

In accordance with another aspect of the preset invention, a target flow detection apparatus of a wireless communication system is provided. The apparatus includes a packet receiver for receiving a packet, a state determiner for determining a behavior state of the packet, a signature memory for storing a plurality of behavior signatures to be compared with the behavior state, and a candidate determiner for retrieving, when the behavior state matches one of the stored behavior signatures, a target flow corresponding to the behavior signature and for instructing a packet processor to process the target flow.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating architecture of a wireless communication system according to an exemplary embodiment of the present invention;

FIG. 2 is a diagram illustrating packet flows in the wireless communication system of FIG. 1 according to an exemplary embodiment of the present invention;

FIG. 3 is a block diagram illustrating a configuration of a target flow detection apparatus according to an exemplary embodiment of the present invention;

FIG. 4 is a flowchart illustrating a target flow detection method according to an exemplary embodiment of the present invention;

FIG. 5 is a flowchart illustrating details of the behavior state-checking procedure of FIG. 4 according to an exemplary embodiment of the present invention;

FIG. 6 is a flowchart illustrating details of the behavior state analysis procedure of FIG. 4 according to an exemplary embodiment of the present invention;

FIG. 7 is a flowchart illustrating details of the target flow detection procedure of FIG. 4 according to an exemplary embodiment of the present invention; and

FIG. 8 is an exemplary diagram illustrating the behavior state analysis procedure of FIG. 6 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term “target flow” denotes the packet flow generated by using a specific radio communication protocol or a specific application, e.g. Transmission Control Protocol (TCP) and User Datagram Protocol (UDP). The packet flow is identified by a unique 5-Tuple (Source IP Address, Destination IP Address, Source Port number, Destination Port number, and Protocol (TCP/UDP). The term “serving flow” means the TCP or UDP packet flow before the target flow is detected in the wireless communication system. The target flow may be detected through the serving flow in the wireless communication system. Detecting the target flow may be understood as “to determine the radio communication protocol or application generating the target flow.”

The term “behavior state” denotes a state characterized by the wireless communication protocol or application that generates the packet in the wireless communication system. The behavior state refers to external, e.g. numerical, properties of the packet. The behavior state includes a number of packets per size and delivery direction of the packet generated during the given behavior state monitoring period. The term “state summary” denotes the information on the summary in the form of bitmap of behavior state per period. The state summary information can be generated depending on the packet size.

The term “behavior signature” denotes the information on the condition for detecting the target flow corresponding to the serving flow in the wireless communication system. The behavior signature is configured in correspondence with each target flow. The behavior signature defines a number of TCP or UDP packets per size and the delivery direction of the packets to be generated during the given behavior state monitoring period for comparing the behavior states. The term “signature summary” denotes the information on the summary in the form of the bitmap of the behavior signature per period. The signature summary is generated according to the size of the packet in the behavior signature.

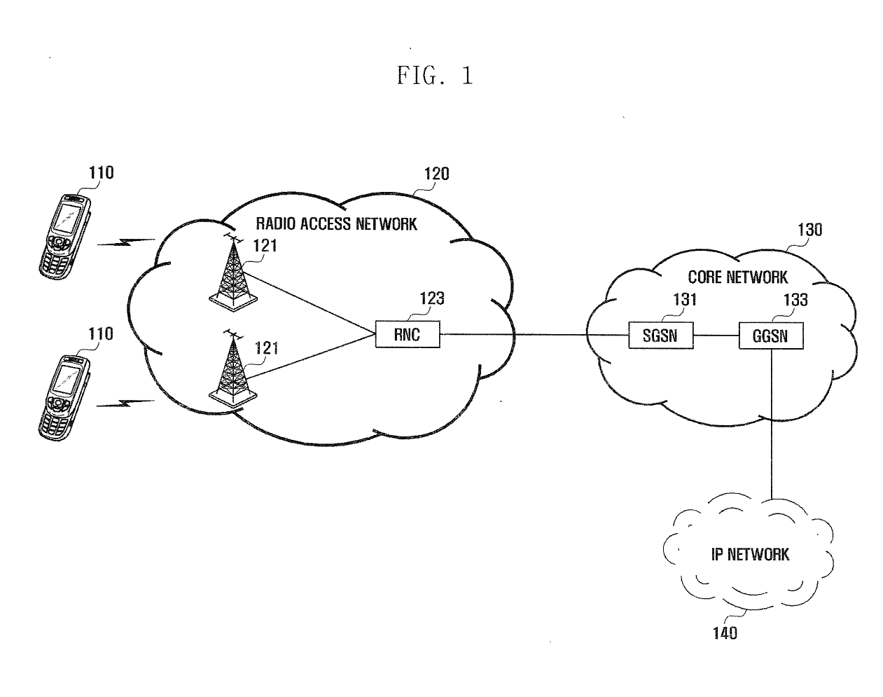

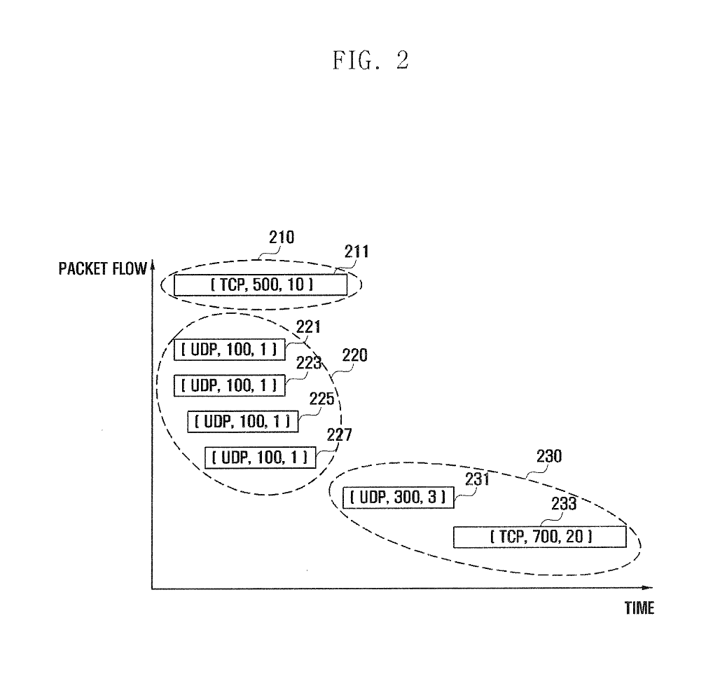

FIG. 1 is a schematic diagram illustrating architecture of a wireless communication system according to an exemplary embodiment of the present invention, and FIG. 2 is a diagram illustrating packet flows in the wireless communication system of FIG. 1.

Referring to FIG. 1, the wireless communication system includes communication terminals 110, a Radio Access Network (RAN) 120, a Core Network (CN) 130, and an Internet Protocol (IP) Network 140.

The communication terminal 100 has mobility and is capable of transmitting and receiving packets. The communication terminal 110 transmits and receives packets in compliance with a radio communication protocol. The communication terminal 100 is capable of executing various applications of which at least one can generate and use packets.

The Radio Access Network 120 corresponds to the UMTS Terrestrial Radio Access Network (UTRAN). The Radio Access Network 120 includes a plurality of base stations 121 and a Radio network Controller (RNC) 123. The base station 121 communicates with the communication terminal 110 via Up interface. The RNC 123 manages the communication terminal 110 and controls radio resource of the base stations 121. The RNC 123 can communicate with the base station 131 via Iu interface. The RNC 123 assigns radio resource to the base stations 121, and each base station 121 allocates the radio resource to the communication terminals 110. The RNC 123 may communicate with the communication terminal directly via radio link.

The core network 130 support the packet exchange of the radio access network 120. The core network 130 includes a Serving GPRS Support Node (SGSN) 131 and a Gateway GPRS Support Node (GGSN) 133. The SGSN 131 manages the mobility of the communication terminal 110 and session for packet exchange and processes authentication and billing. The SGSN 131 is responsible for routing packets. The SGSN 131 may communicate with the RNC 123 of the radio network 120 via the Iu interface. The GGSN 133 manages IP addresses of the communication terminals 110 and session for packet exchange. The GGSN 133 is also responsible for the packet routing function. The GGSN 133 may communicate with the SGSN 131 via Gn interface. In the core network 130, the SGSN 131 and GGSN 133 are provided with a target flow detection apparatus and Behavior-based Detection Engine (BDE) for performing the deep packet inspection on the packets for the communication terminal 110 according to an exemplary embodiment of the present invention.

FIG. 2 is a diagram illustrating packet flows in the wireless communication system of FIG. 1 according to an exemplary embodiment of the present invention.

Referring to FIG. 2, the core network 130 may deliver the packet in a flow varying as time progresses. The packet flows are arranged on the same line in FIG. 2, exemplary embodiments of the present invention are not limited thereto. The individual packet flows may be arranged on different lines. The packet flow may be identified by the source IP, source port, destination IP, destination port, and identity information of the radio communication protocol associated with the corresponding packet. The sender of the packet flow may be one of the communication terminal 110 and the IP network 140, and the receiver of the packet flow can be one of the IP network 140 and the communication terminal 110.

The core network 130 delivers the first packet 211 in compliance with the Transmission Control Protocol (TCP). The first packet 211 may be formed to have a size of 500 bytes. The core network 130 can deliver ten second packets to the same destination. The core network 130 delivers the 2-1^{st} packet 221, the 2-2″ packet 223, the 2-3^{rd} packet 225, and the 2-4^{th} packet in compliance with the User Datagram Protocol (UDP). Each of the 2-1^{st}, 2-2^{nd}, 2-3^{rd}, and 2-4^{th} packets 221, 223, 225, and 227 may be 100 bytes in size. The core network 130 delivers the 2-1^{st},2-2^{nd},2-3^{rd}, and 2-4^{th} packets 221, 223, 225, and 227 to four destinations in distributed manner. The core network 130 delivers the 3-1^{st} packet 231 in compliance with the UDP and the 3-2^{nd} packet 233 in the packet form of the target flow in compliance with the TCP at the rate of average 20 packets per second. The 3-1^{st} packet 231 may have a size of 300 bytes, and the 3-2^{nd} packet 233 may have a size of 700 bytes. The core network 130 may deliver the three 3-1^{st} packets 231 to the same destination and then the 3-2^{nd} packets to the same destination at a rate of average 20 packets per second.

The IP network 140 manages and delivers packets to the communication terminal 110. The IP network 140 receives the packet from the communication terminal via the radio access network 120 and the core network 130 and manages the received packets. The IP network 140 sends packets to the communication terminal 110 via the core network 130 and the radio access network 120. The IP network 140 may communicate with the GGSN of the core network 130 via Gi interface.

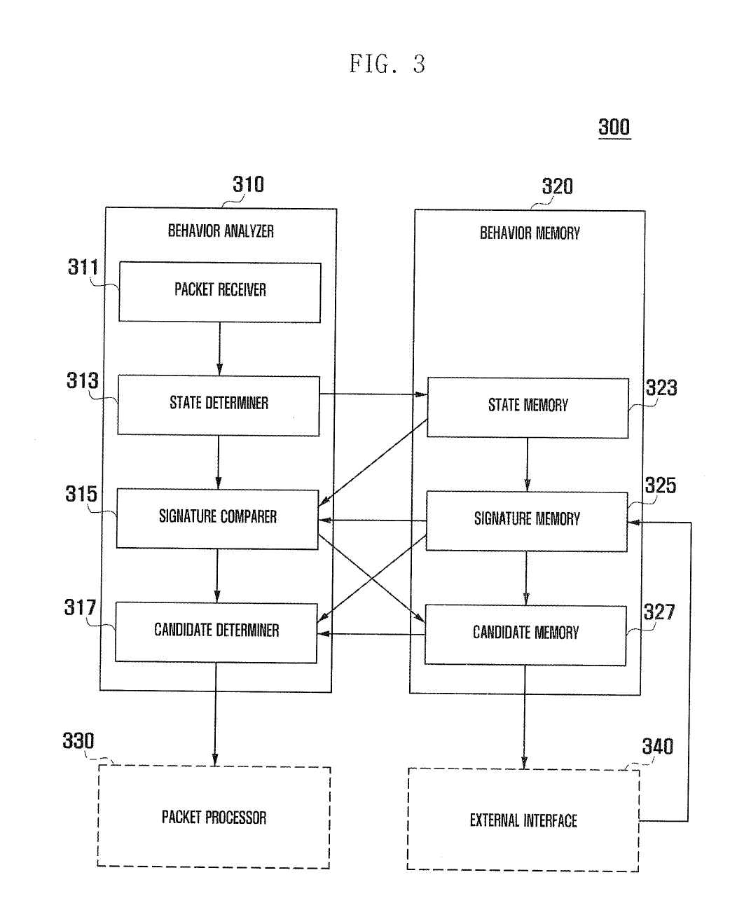

FIG. 3 is a block diagram illustrating a configuration of a target flow detection apparatus according to an exemplary embodiment of the present invention. Target flow detection apparatus can be integrated in one of the SGSN and GGSN of the core network.

Referring to FIG. 3, the target flow detection apparatus 300 includes a behavior analyzer 310 and a behavior memory 320. The target flow detection apparatus 300 is connected to a packet processor 330 and an external interface 340.

The behavior analyzer 310 of the target flow detection apparatus 300 performs deep packet inspection. The behavior analyzer 310 receives and analyzes a packet and retrieves a target flow. Once the target flow is detected, the behavior 310 instructs the packet processor 330 to process the corresponding target flow. The behavior analyzer 310 includes a packet receiver 311, a state determiner 313, a signature comparer 315, and a candidate determiner 317.

The packet receiver 311 receives packets. The packet receiver 311 receives the packets from the communication terminal 110 via the radio access network 120. The packet receiver 311 may also receive the packet from the IP network 140.

The state determiner 313 determines the behavior state of the packet. The state determiner 313 determines the external, e.g. numerical, properties of the packet to determine the behavior state of the packet. The behavior state includes a number of TCP or UDP packets per size and delivery direction of the packet generated during the given behavior state monitoring period. The state determiner 313 may also generate state summary information in the form of a bitmap per behavior state. The state determiner 313 may generate the state summary information according to the packet size.

The signature comparer 315 compares the behavior state of the packet with the behavior signatures stored previously. The signature comparer 315 determines whether the behavior state of the packet matches the behavior signatures. The behavior signature defines a number of TCP or UDP packets per size and the delivery direction of the packets to be generated during the given behavior state monitoring period for comparing the behavior states. The signature comparator 315 compares the state summary information of the behavior state with the signature summary information of the behavior signature to determine whether the state summary information and the signature summary information match each other. The signature summary information may be generated according to the size in the behavior signature. If the state summary information matches the signature summary information, the signature comparer 315 determines whether the behavior state of the packet matches the behavior signatures.

The candidate determiner 317 retrieves the target flow using the behavior signature. If the behavior state of the packet matches at least one of the behavior signatures, the candidate determiner 317 retrieves the target flow according to the corresponding behavior signature. The candidate determiner 317 may determine whether the matching candidate corresponding to the address information of the packet is stored previously. If the matching candidate is stored, the candidate determiner 317 identifies the target flow corresponding to the behavior signature of the matching candidate. The address information of the packet may be the IP address of the communication terminal 110.

The behavior memory 320 includes at least one program memory and at least one data memory. The program memory stores programs for performing the deep packet inspection by means of the target flow detection apparatus. The data memory stores the data generated in association with the operation of the programs. The behavior memory 320 includes a state memory 323, a signature memory 325, and a candidate memory 327.

The state memory 323 stores the behavior state corresponding to the address information of the packet, i.e., the behavior state corresponding to the IP address of the communication terminal 110. The state memory 323 manages the behavior state per information address in the form of a state hash table. The state hash table is composed of the fields for storing a number of TCP or UDP packet per size generated during the given behavior state monitoring period and the packet deliver directions. The state hash table may also store the port information of the communication terminal 110. The state memory 323 may also store the state summary information corresponding to the behavior state.

The signature memory 325 stores the state signatures. The signature memory 325 stores the serving flows and target flows matching the behavior signatures. In the signature memory, the behavior signatures may be changed according to the off line command input through the external interface 340. For example, in order to detect the 3-2″ packet 233 as the target flow, the signature memory 325 may store the first behavior signature 210, the second behavior signature 220 and the third behavior signature of the 3-1^{st} packet 321 for detecting the preceding serving flow, as shown in FIG. 2 in a wireless communication system. The third behavior signature 230 of FIG. 2 includes the signature for the target flow (second 3-2^{nd} packet 233). The signature memory 325 may store the signature summary information per behavior Signature.

The behavior signature may be defined as shown in table 1. The behavior signature is composed of at least one signature item. The ‘protocol type (proto)/average packet size (avg_pkt_size)/accumulated packet count (pkt_count)/delivery direction’ denotes a signature item. ‘[ ]’ indicates an optional item; ‘,’ indicates that their signature items are discriminated regardless of their creation order; and ‘;’ indicates that the signature items are discriminated according to their creation order. ‘term/creation period (duration)’ is a condition for creating the corresponding behavior signature and indicates that the signature items should be generated in the corresponding creation period. The behavior signature is configured in correspondence to a specific target flow. ‘protocol type (proto)/lowest limit<average packet size (aps)<highest/lowest<average number of packets (pps)<highest’ denotes the condition for detecting the target flow corresponding to the behavior signature.

TABLE 1
bde{

// Behavior condition definition block
proto/avg_pkt_size/pkt_count[/r].
[proto/avg_pkt_size/pkt_count[/r]], ...
[; [proto/avg_pkt_size/pkt_count[/r]], ...]; term/duration:
// Target condition definition block
proto/[lowerbound<] aps [<upperbound]/pkt_count | [lowerbound<]
pps [<upperbound]

}

The candidate memory 327 stores at least one matching candidate corresponding to the address information of the packet, i.e. the IP address of the communication terminal 110. The candidate memory 327 stores the address information and the ID of at least one of behavior signatures matching each other as the matching candidate and manages the matching candidate in the form of a candidate hash table. The matching candidate is the record in which the target flow of the corresponding behavior signature is detected in correspondence with the previous address information.

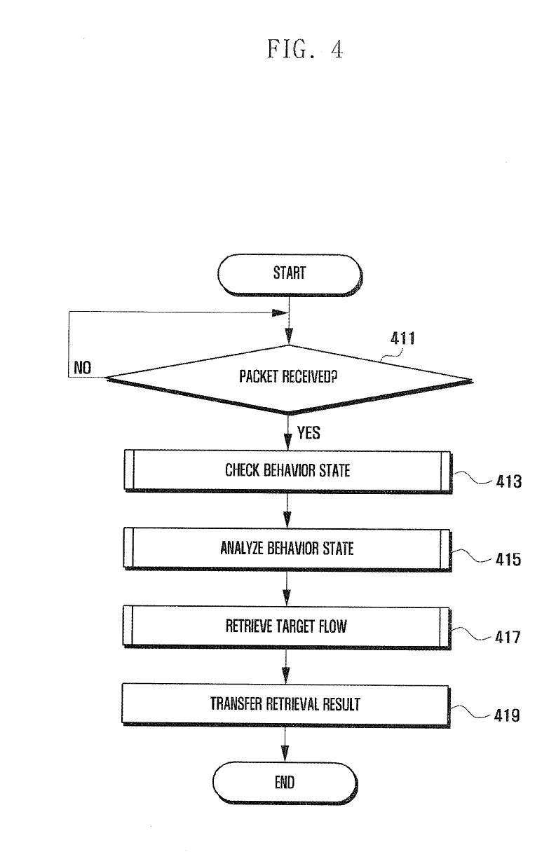

FIG. 4 is a flowchart illustrating a target flow detection method according to an exemplary embodiment of the present invention.

Referring to FIG. 4, the target flow detection method starts with the arrival of a packet in the target flow detection apparatus at step 411. The packet receiver 311 determines whether the packet is received in uplink from the radio access network 120 or in downlink from the IP network 140. The packet receiver 311 determines the source and destination addresses of the packet. If the packet is received from the communication terminal 110, the source address information of the packet can be the IP address of the communication terminal. Otherwise, if the packet is received from the IP network 140, the destination address information of the packet can be the IP address of the communication terminal 110.

The behavior analyzer 310 determines the behavior state of the packet at step 413. The packet determiner 313 determines the external, e.g. numerical, property, of the packet to determine the behavior state of the packet. The state determiner 313 may manage the behavior state corresponding to the address information of the packet. A procedure for determining the behavior state is described below.

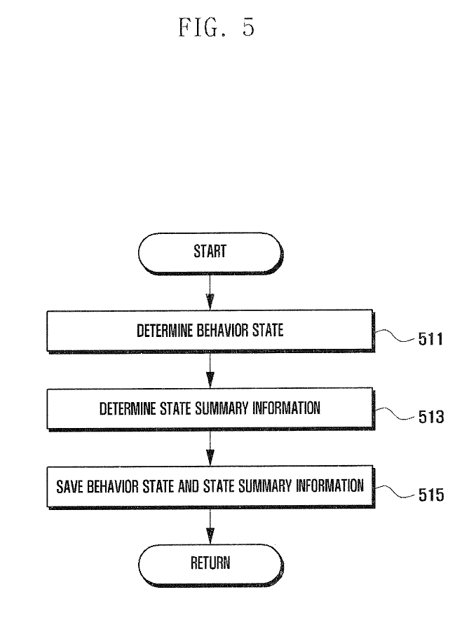

FIG. 5 is a flowchart illustrating details of the behavior state-checking procedure of FIG. 4 according to an exemplary embodiment of the present invention.

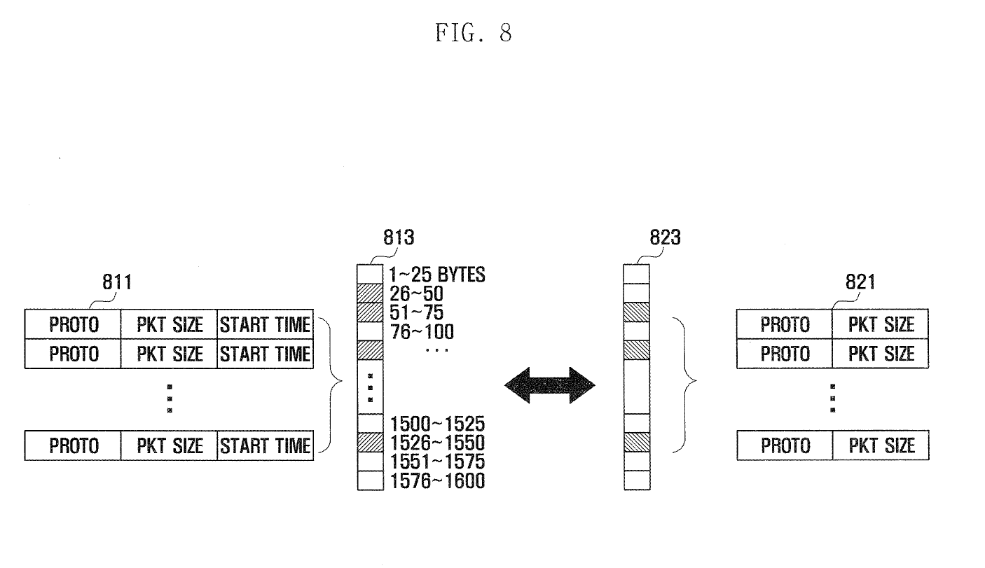

Referring to FIG. 5, the state determiner 313 determines the behavior state 811 of the packet (see FIG. 8) at step 511. The state determiner 313 determines a number of TCP or UDP packets per size to be generated during the given behavior state monitoring period and packet deliver direction. The state determiner 313 may store a plurality of size periods defined in advance and determine the size period corresponding to the packet size. If the packet is received from the communication terminal 110, the state determiner 313 determines the delivery direction as uplink. If the packet is received from the communication terminal 110, the state determiner 313 determines the delivery direction as downlink.

The state determiner 313 determines the state summary information 813 of the behavior state 811 (see FIG. 8) at step 513. The state determiner 313 generates the state summary information 813 in the form of bitmap per period of the behavior state 811. The state determiner 313 may generate the state summary information 813 according to the packet size. For example, the state determiner 313 may define the packet sizes such that individual bits of a 64-bit word correspond to the period having the size of 25 bits and generate the state summary information 813 of the corresponding packet by setting the bits of the period corresponding to the packet size.

The state determiner 313 stores the behavior state 811 and the state summary information 813 in the state memory 323 at step 515, and the procedure returns to FIG. 4. The state determiner 313 stores the address information of the packet in match with the corresponding behavior state 811 and the state summary information 813. If the address information of the packet has been stored already, the state determiner 313 stores the behavior state 811 and the state summary information 813.

The behavior analyzer 310 analyzes the behavior state of the packet at step 415. The signature comparer 315 compares the behavior state of the packet with the previously stored behavior signatures. The signature comparer 315 determines whether the behavior state of the packet matches at least one of the behavior signatures. The behavior state analysis procedure of the signature comparer 315 is described below.

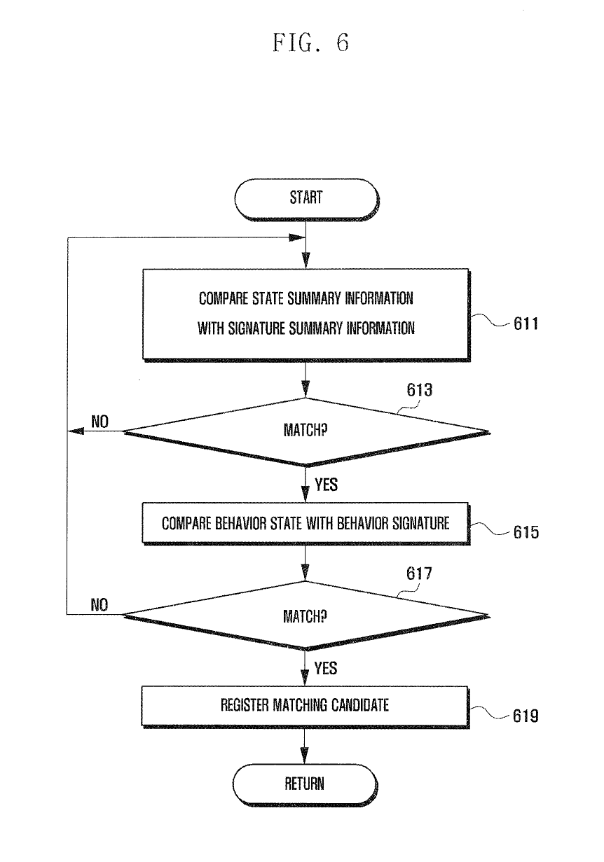

FIG. 6 is a flowchart illustrating details of the behavior state analysis procedure of FIG. 4 according to an exemplary embodiment of the present invention. FIG. 8 is an exemplary diagram illustrating the behavior state analysis procedure of FIG. 6 according to an exemplary embodiment of the present invention.

Referring to FIG. 6 and FIG. 8, the signature comparer 315 compares the state summary information 813 of the behavior state 811 with the signature summary information 823 of the respective behavior signatures 821 at step 611, and determines at step 613 whether the state summary information 813 matches the signature information 823. The behavior signature 821 and the signature summary information 823 are stored in the signature memory 325 as shown in FIG. 8. The behavior signature 821 defines the number of TCP or UDP packets per size that should be generated during the behavior state monitoring period given for comparison of the behavior state 811 and the packet transfer direction. The signature summary information 823 may be generated according to the size defined in the behavior signature in the form of bitmap per period of the behavior signature 821.

For example, the signature summary information 823 may be generated in a structure in which a number of bits for the period corresponding to the size defined in the behavior signature 821, in a 64-bit word defined such that the period corresponding to the size of 25 bits is mapped to individual bits. The signature comparer 315 compares the state summary information 813 retrieved from the state memory 323 with the signature summary information 823 retrieved from the signature memory 325. For example, the signature comparer 315 may compare the state summary information 813 with the signature summary information 325 using equation (1). The signature comparer 815 determines whether equation (1) is satisfied to determine whether the state summary information 813 matches the signature summary information 823.

(A′″ and′″ B)′″×or′″ B′″=′″0 (1)

where A denotes the state summary information, and B denotes the signature summary information.

If the state summary information 813 matches the signature summary information 823 at step 613, the signature comparer 315 compares the behavior state 811 with the behavior signature 821 at step 615 to determine whether the behavior state and behavior signature match each other at step 617. The signature comparer 315 compares the behavior state 811 retrieved from the state memory 323 with the behavior signature 821 retrieved from the signature memory 325. If the behavior state 811 matches the behavior signature 821 at step 617, the signature comparer 315 registers the matching candidate with the candidate memory 327 at step 619, and the procedure returns to FIG. 4. The signature comparer 315 stores the IP address of the communication terminal 110 and the ID of the corresponding behavior signature 821 in the form of matching candidate.

Returning to FIG. 4, the behavior analyzer 310 retrieves the target flow corresponding to the behavior state of the packet at step 417. The behavior analyzer 310 predicts the probability of the immediate appearance of the target flow corresponding to the serving flow using the packet as the serving flow. The candidate determiner 317 retrieves the target flow using the behavior signature. If the behavior state of the packet matches at least one of the behavior signatures, the candidate determiner 317 retrieves the target flow according to the corresponding behavior signature. The target flow detection procedure of the candidate determiner 317 is described below.

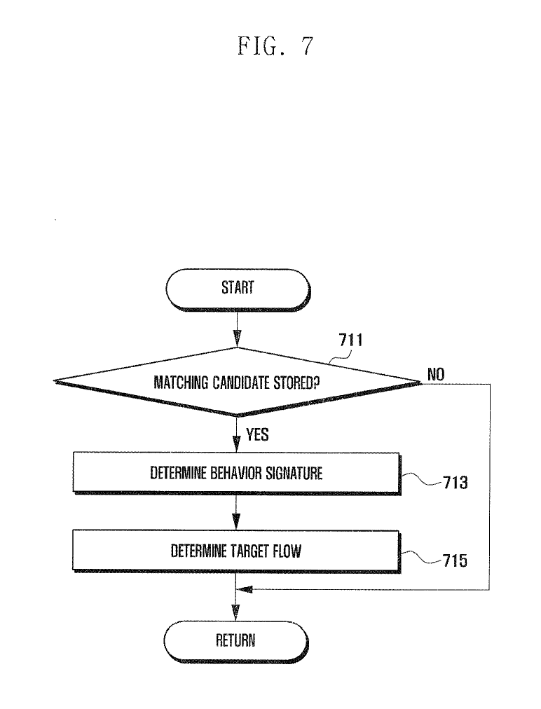

FIG. 7 is a flowchart illustrating details of the target flow detection procedure of FIG. 4 according to an exemplary embodiment of the present invention.

Referring to FIG. 7, the candidate determiner 317 determines whether a matching candidate corresponding to the address information of the communication terminal 110 is stored at step 711. The candidate determiner 317 searches the candidate memory 327 to retrieve at least one matching candidate including the IP address of the communication terminal 110. The candidate determiner 317 excludes the matching information registered with respect to the current packet among the matching candidates stored in the candidate memory 327.

If it is determined that there is no matching candidate stored at step 711, the candidate determiner 317 returns to the method of FIG. 4. Otherwise, if it is determined, at step 711, that there is a stored matching candidate, the candidate determiner 317 determines the behavior signature by referencing the corresponding matching candidate at step 713. The candidate determiner 317 acquires the ID of the behavior signature from the corresponding matching candidate. The candidate determiner 317 also determines the target flow corresponding to the signature and then returns to the method of FIG. 4. The candidate determiner 317 acquires the corresponding behavior signature from the signature memory 325 using the corresponding ID and determines the target flow configured in associated with the corresponding behavior signature.

The behavior analyzer 310 transfers the detection result to the packet processor 330 at step 419. The behavior analyzer 310 instructs the packet processor 330 to process the corresponding target flow according to the detection result. The behavior analyzer 310 notifies the packet processor 330 of the radio communication protocol or application associated with the target flow.

According to exemplary embodiments of the present invention, the target flow detection apparatus 300 of a wireless communication system can perform the deep packet inspection without determining the content of the packet. The target flow detection apparatus determines the behavior state of the received packet and compares the behavior state with the behavior signatures stored in advance to detect the target flow. The target flow detection apparatus 300 determines the radio communication protocol or application of the target flow and notifies of the protocol or the application such that the packet processor 330 can process the packet efficiently.

As described above, the target flow detection apparatus and method for a wireless communication system is capable of performing the deep packet inspection without determining the content of the packet. The target flow detection apparatus and method of the present invention determines the behavior state of the received packet and compares the behavior state of the packet with the behavior signatures stored in advance to perform the deep packet inspection, thereby detecting the target flow.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for detecting a target flow in a wireless communication system, the method comprising:
receiving a packet;
determining a behavior state of the packet;
comparing the behavior state with a plurality of stored behavior signatures;
retrieving, when the behavior state matches one of the stored behavior signatures, a target flow corresponding to the behavior signature; and
instructing a packet processor to process the target flow.

2. The method of claim 1, wherein the behavior state comprises a number of packets per size that are generated during a given behavior state monitoring period and a packet transfer direction.

3. The method of claim 2, wherein the behavior signatures are configured to match individual target flows and includes the number of packets per size that are generated during the behavior state monitoring period given for comparing with the behavior state and the packet transmission direction.

4. The method of claim 3, wherein the comparing of the behavior state comprises:
comparing state summary information of the behavior state with signature summary information of the behavior signatures; and
comparing, when the state summary information matches the signature summary information, the behavior state with the behavior signature.

5. The method of claim 4, wherein the state summary information is generated according to a size of the packet in the form of bitmap per period of behavior state, and the signature summary information is generated according to a packet size in the behavior signature as the bitmap per period of the behavior signature.

6. The method of claim 1, wherein the retrieving of the target flow comprises detecting, when the behavior signature is stored in advance as a matching candidate corresponding to address information of the packet, the target flow corresponding to the behavior signature.

7. The method of claim 1, further comprising:
storing, when the behavior state matches at least one of the behavior signatures, address information of the packet and the behavior signature as a matching candidate.

8. The method of claim 7, further comprising:
judging whether the packet is received from a communication terminal or is to be transmitted to the communication terminal; and
determining address information of the packet.

9. An apparatus for detecting a target flow in a wireless communication system, the apparatus comprising:
a packet receiver for receiving a packet;
a state determiner for determining a behavior state of the packet;
a signature memory for storing a plurality of behavior signatures to be compared with the behavior state; and
a candidate determiner for retrieving, when the behavior state matches one of the behavior signatures, a target flow corresponding to the behavior signature and for instructing a packet processor to process the target flow.

10. The apparatus of claim 9, wherein the behavior state comprises a number of packets per size that are generated during a given behavior state monitoring period and a packet transfer direction.

11. The apparatus of claim 10, wherein the behavior signatures are configured to match individual target flows and includes the number of packets per size that are generated during the behavior state monitoring period given for comparing with the behavior state and the packet transmission direction.

12. The apparatus of claim 11, further comprising a signature comparer for comparing state summary information of the behavior state with signature summary information of the behavior signatures and for comparing, when the state summary information matches the signature summary information, the behavior state with the behavior signature.

13. The apparatus of claim 12, wherein the state summary information is generated according to a size of the packet in the form of bitmap per period of behavior state, and the signature summary information is generated according to a packet size in the behavior signature as the bitmap per period of the behavior signature.

14. The apparatus of claim 9, wherein the candidate determiner retrieves, when the behavior signature is stored in advance as a matching candidate corresponding to address information of the packet, the target flow corresponding to the behavior signature.

15. The apparatus of claim 9, wherein the candidate determiner stores, when the behavior state matches at least one of the behavior signatures, address information of the packet and the behavior signature as a matching candidate.

16. The apparatus of claim 15, wherein the packet receiver judges whether the packet is received from a communication terminal or is to be transmitted to the communication terminal and determines address information of the packet.
